(19) United States
(12) Patent Application Publication
(10) Pub. No.: US 2016/0178929 A1
(43) Pub. Date: Jun. 23, 2016

(54) Combination Structure of Eyeglasses Temple

(71) Applicant: HWA MEEI OPTICAL CO., LTD., Tainan City (TW)

(72) Inventor: Chih-Ming Chen, Tainan City (TW)

(21) Appl. No.: 14/578,347

(22) Filed: Dec. 20, 2014

(51) Int. Cl. G02C 5/14; G02C 5/22

(52) U.S. Cl. CPC G02C 5/146; G02C 5/2281; G02C 2200/08

(57) ABSTRACT

The present invention provides a combination structure for connecting a temple and a glasses frame of a pair of eyeglasses. The glasses frame includes two lateral ends, and a connecting member is pivotally fitted at one of the lateral ends of the glasses frame. The connecting member includes a pivotal portion, a snap-fit portion, and a recess between the snap-fit portion and the pivotal portion. The temple is detachably connected with the connecting member and includes a groove and a joining rib which separates the groove into a front joining groove and a rear joining groove. The pivotal portion and the snap-fit portion of the connecting member are respectively held in the front and the rear joining grooves, and the joining rib is held in the recess of the connecting member. The temple and the connecting member are collectively rotatable relative to the glasses frame.

### BACKGROUND OF THE INVENTION

1. Field of the Invention

The present invention relates to a pair of eyeglasses with replaceable temples and, more particularly, to a combination structure of a temple and a glasses frame.

2. Description of the Related Art

In the era of material life promoted, people with novelty aspiration are fastidious about portable decorative objects. For example, sunglasses or leisure eyeglasses are popularized among persons who value the eyeglasses aesthetically matching costumes. In this regard, a user who prefers versatile fancy sunglasses or leisure eyeglasses may change temples in a pair of eyeglasses frequently to match his/her mood or costumes but finally buy a new pair of eyeglasses without cost effectiveness because temples of the eyeglasses are difficultly replaced.

Specifically, a pair of eyeglasses conventionally includes a frame and two temples pivotally fitted at both sides of the frame. Each temple directly joining and corresponding to the frame with a pivotal member such as a screw or a pin is folded or unfolded. However, a user intending to change an old temple usually makes use of a tool to remove the pivotal member and strenuously secure it at a new temple. Furthermore, the pivotal member externally exposed and easily smudged or rusted has negative effects on appearance of a pair of eyeglasses and smoothness of a temple to be rotated about the pivotal member.

### BRIEF SUMMARY OF THE INVENTION

Thus, an objective of the present invention is to provide a combination structure of an eyeglasses temple which features temples removed and secured conveniently, temples rotatable smoothly, overall appearance, simplified structure and extended service life.

To achieve this and other objectives, a combination structure of an eyeglasses temple of the present invention includes a glasses frame, a connecting member, and a temple. The glasses frame includes two spaced lateral ends. The connecting member is pivotally fitted at one of the lateral ends of the glasses frame and includes a main body. A pivotal portion is formed on an inner face of the main body, and a snap-fit portion is formed at a rear section of the main body. A recess is formed between the snap-fit portion and the pivotal portion. The temple includes front and rear ends spaced in a length direction of the temple. The front end of the temple is detachably connected with the connecting member. A groove is formed in an inner surface of the front end of the temple, and a joining rib is formed on the inner surface of the front end of the temple and extends across the groove to divide the groove into a front joining groove and a rear joining groove spaced from the front joining groove in the length direction. The rear joining groove is in communication with the front joining groove. The pivotal portion and the snap-fit portion of the main body are respectively held in the front joining groove and the rear joining groove, and the joining rib is engaged in the recess of the main body, so that the temple and the connecting member can be collectively rotated relative to the glasses frame.

In a preferred form, the temple further includes upper and lower ends spaced in a width direction perpendicular to the length direction of the temple. The groove is located between the upper and lower ends of the temple in the width direction, and the joining rib extends in the width direction. A protrusion is provided on each of upper and lower portions of the main body of the connecting member, and an indentation is provided in each of upper end lower edges of the groove of the temple and engaged with one of the protrusions of the main body.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is a perspective view of a pair of eyeglasses in accordance with an embodiment of the present invention.

FIG. 2 shows an exploded view of the pair of eyeglasses of FIG. 1.

FIG. 3 is a schematic view illustrating a connecting member and a glasses frame in FIG. 2, both of which links together.

FIG. 4 is a partial, sectional view of the pair of eyeglasses of FIG. 1.

FIG. 5 is a partial, enlarged view of the pair of eyeglasses of FIG. 4.

FIG. 6 is an exploded view of a temple and the connecting member of FIG. 2.

FIG. 7 is a sectional view similar to FIG. 5, with a snap-fit portion of the connecting member moved inward.

FIG. 8 shows another perspective view of the pair of eyeglasses of FIG. 1.

### DETAILED DESCRIPTION OF THE INVENTION

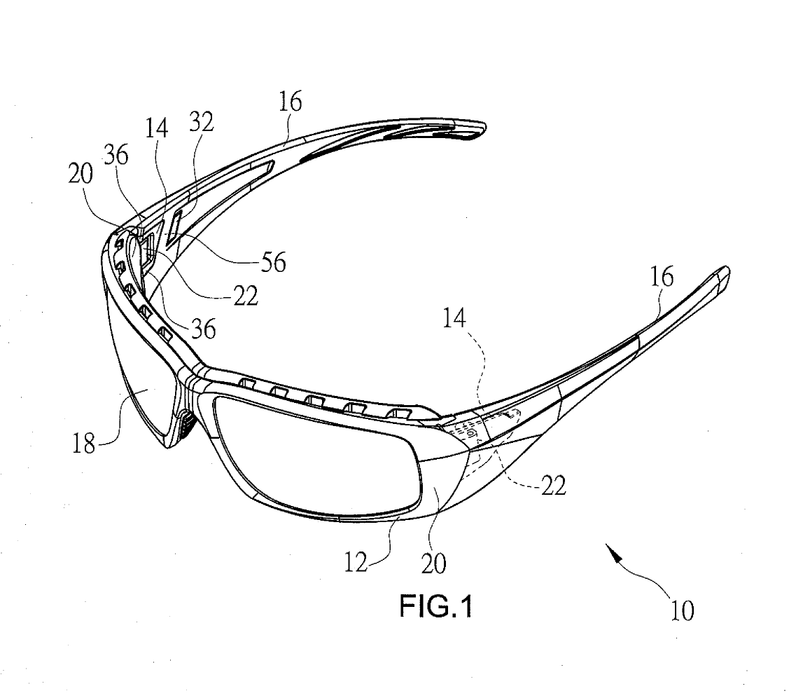

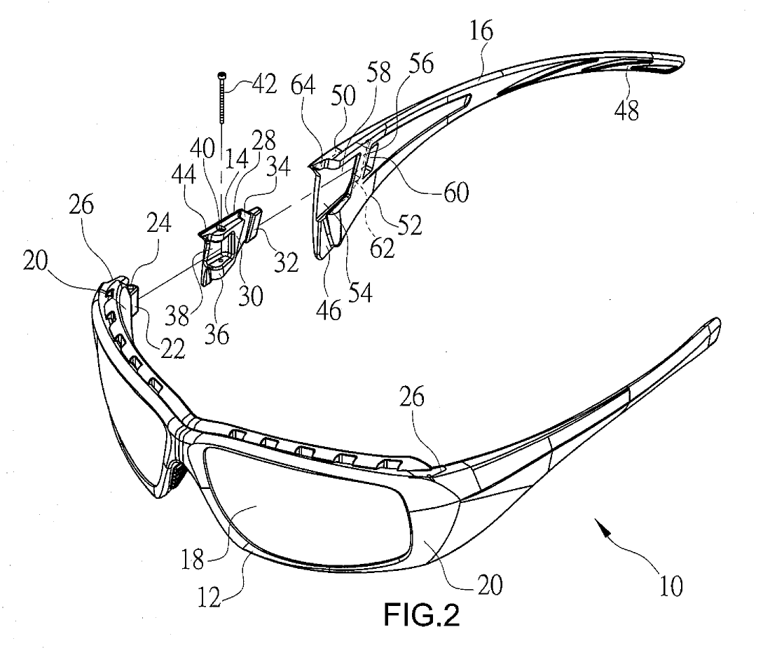

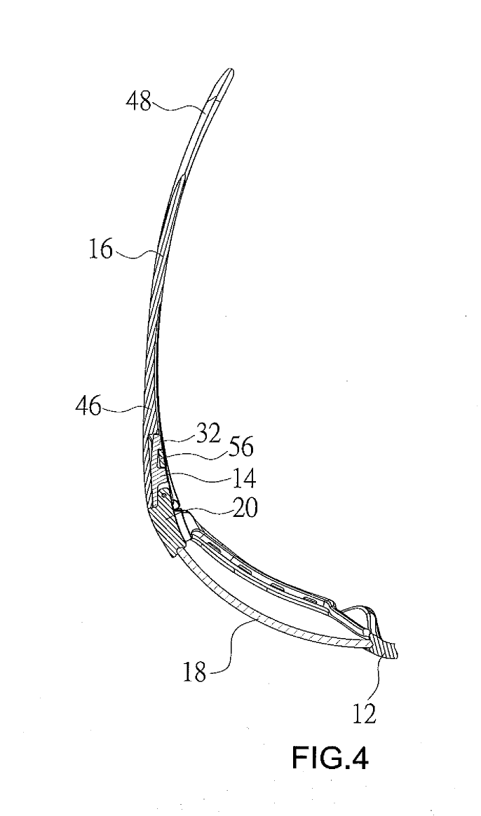

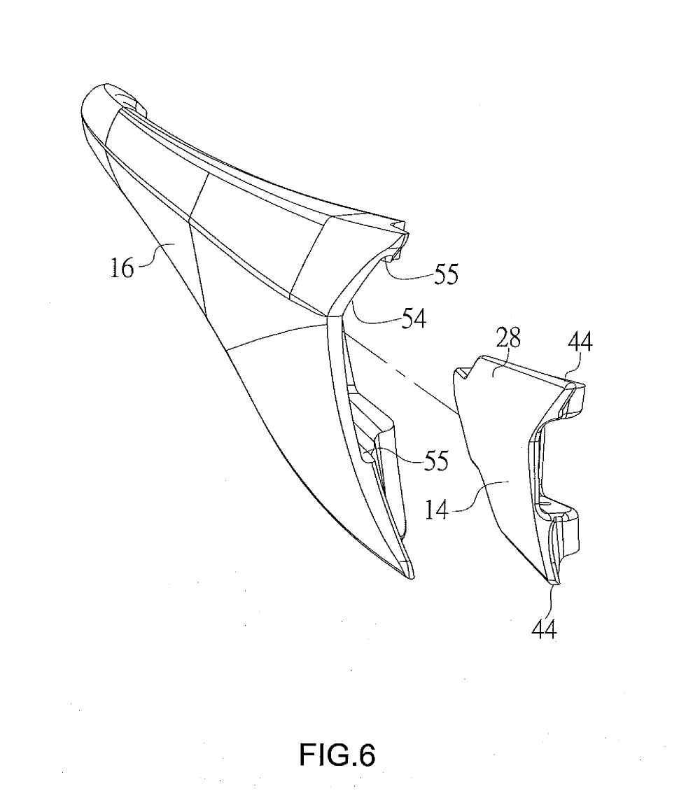

A pair of eyeglasses 10 according to the preferred teachings of the present invention is shown in FIGS. 1 through 8 of the drawings and includes a glasses frame 12, two connecting members (first and second connecting members) 14, and two temples (first and second temples) 16. The eyeglasses 10 may be a pair of sunglasses, leisure eyeglasses, sports eyeglasses, protective goggles, nearsighted eyeglasses, farsighted spectacles, presbyopic glasses, etc. The glasses frame 12 is made of materials including, without limitation, metal, alloy, or plastic. Both the connecting members 14 and the temples 16 are made of plastic, rubber, or metal. The connecting members 14 and the corresponding temples 16 which are respectively identical to each other in structure are explained according to one of the connecting members 14 and one corresponding temple 16.

The glasses frame 12 is provided with at least one lens 18. In this embodiment, two lenses 18 are provided on the glasses frame 12. The glasses frame 12 includes two lateral ends 20 spaced in a longitudinal direction, and each of the lateral ends 20 includes a protruded joining portion 22 for engaging with a corresponding connecting member 14. Each of the joining portions 22 is provided with a through-hole 24. Furthermore, each of the lateral ends 20 is formed with at least one concave positioning portion 26.

The connecting members 14 are pivotally fitted at the lateral ends 20 of the glasses frame 12, respectively. Each of the connecting members 14 includes a strip main body 28 which has a protruded pivotal portion 30 formed on an inner face of a front section thereof. A snap-fit portion 32 is provided at a rear section of the main body 28, and a recess 34 is formed between the snap-fit portion 32 and the pivotal portion 30. The pivotal portion 30 includes two spaced pivotal arms 36 defining an interspace 38 therebetween for accommodating a corresponding joining portion 22 of the glasses frame 12. Two pin holes 40 which align with each other are formed in the pivotal arms 36. Each joining portion 22 of the glasses frame 12 is held between the pivotal arms 36 of a corresponding connecting member 14 with a pivot 42 inserted into the pin holes 40 and the through-hole 24 of the joining portion 22 for combination of the pivotal portion 30 and the joining portion 22, so that the connecting member 14 can be rotated relative to the glasses frame 12 about an axis defined by the pivot 42. Furthermore, a protrusion 44 is provided on each of upper and lower portions of the main body 28 (see FIG. 0). To be noted, the joining portion 22 of the glasses frame 12 and the interspace 38 of the connecting member 14 can be interchanged in design. Namely, the interspace is provided in each lateral end 20 of the glasses frame 12, and the joining portion is provided on the connecting member 14 for connecting with the interspace.

Each temple 16 includes front and rear ends 46 and 48 spaced in a length direction thereof. The front end 46 of each temple 16 is detachably connected with one of the connecting members 14, and the rear end 48 of each temple 16 is adapted to be worn on a user's ear. Each temple 16 further includes upper and lower ends 50 and 52 spaced in a width direction thereof perpendicular to the length direction. A groove 54 is formed in an inner surface of the front end 46 of each temple 16 and located between the upper and lower ends 50 and 52 in the width direction. The groove 54 of each temple 16 has a shape corresponding to that of the main body 28 of an associated connecting member 14, so that the main body 28 of the connecting member 14 can be accommodated in the groove 54. In this embodiment, an indentation 55 is provided in each of upper end lower edges of the groove 54 and engaged with a corresponding protrusion 44 of the connecting member 14 for secure combination of the temples 16 and the connecting members 14.

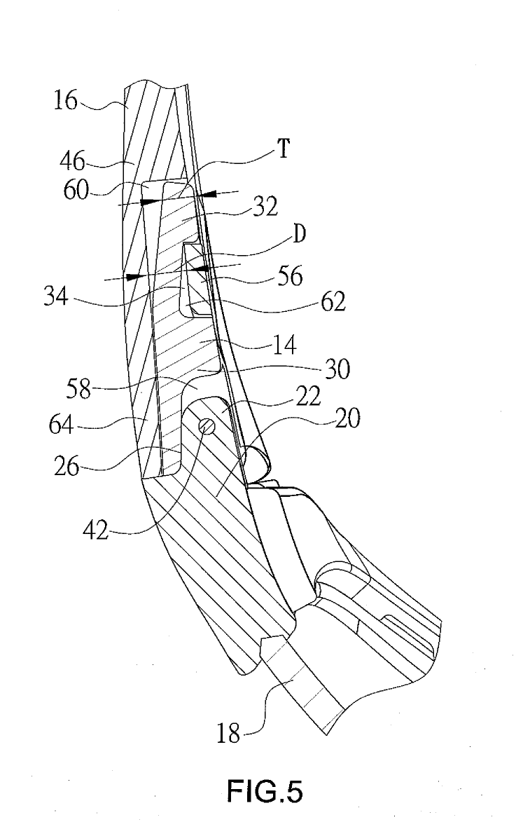

Further, the inner surface of the front end 46 of each temple 16 is provided with a joining rib 56 which extends across the groove 54 in the width direction to divide the groove 54 into a front joining groove 58 and a rear joining groove 60 spaced from the front joining groove 58 in the length direction of the temple 16. The front joining groove 58 extends to the end face of the front end 46 of the temple 16. The rear joining groove 60 is in communication with the front joining groove 58 through a channel 62 defined at an inner side of the joining rib 56. The channel 62 has a depth D slightly greater than a thickness T of the snap-fit portion 32 (see FIG. 5). As such, when the connecting member 14 is inserted into the groove 54 of the temple 16, the pivotal portion 30 and the snap-fit portion 32 of the connecting member 14 are respectively held in the front joining groove 58 and the rear joining groove 60 (see FIG. 5), and the joining rib 56 is received in the recess 34 of the connecting member 14. Furthermore, each temple 16 includes at least one locating portion 64 at the front end 46 thereof which resists a corresponding positioning portion 26 of the glasses frame 12 to complete positioning when each of the temples 16 relative to the glasses frame 12 is outward rotated to a default angle (see FIG. 5). To be noted, the temple 16 is not limited to a specific type but integrated with another component thereon such as MP3 device or manufactured as belts in some preferred embodiments.

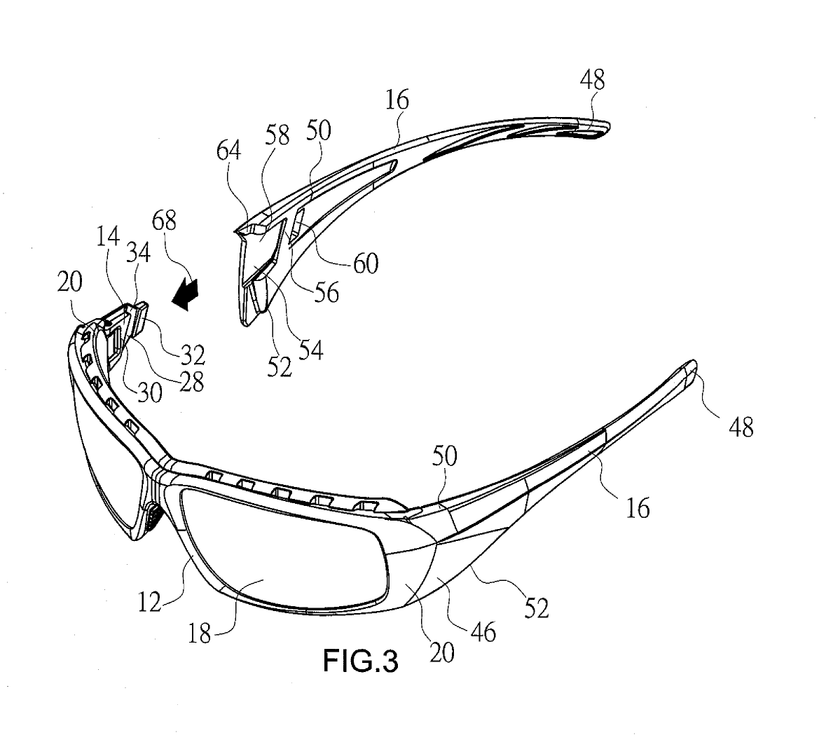

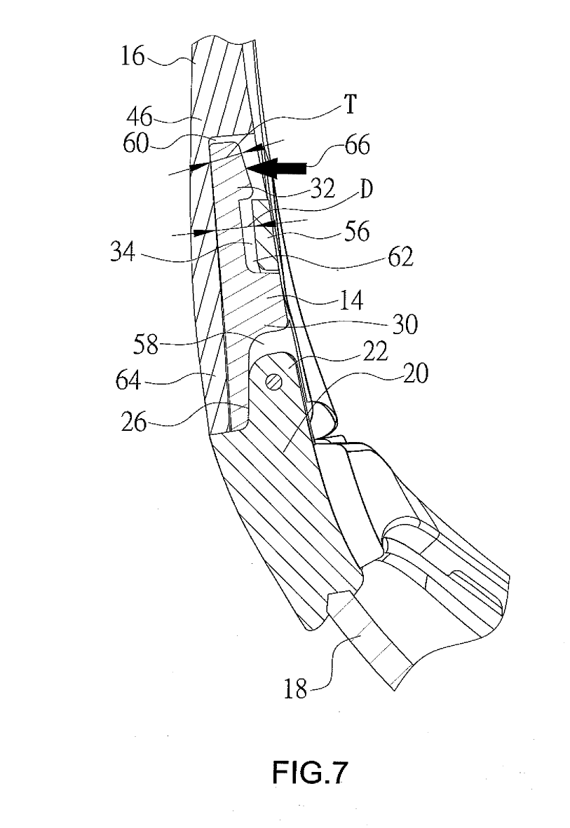

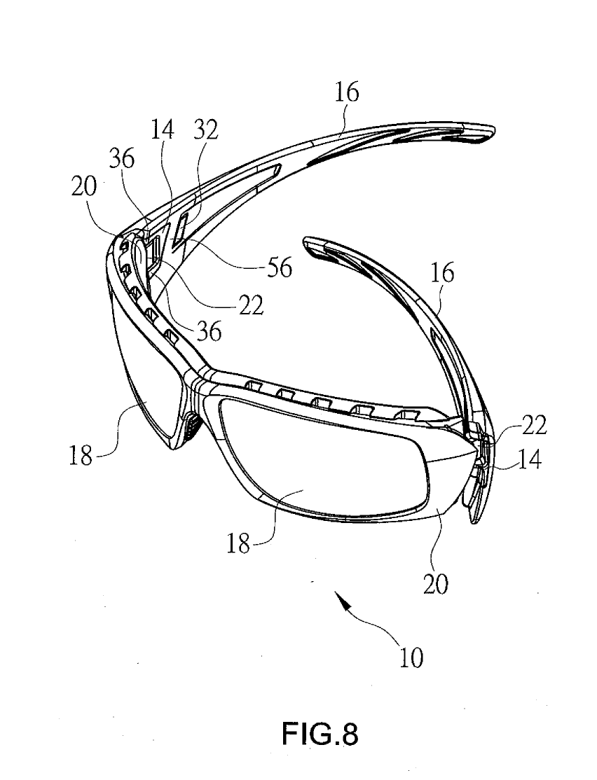

According to the eyeglasses 10 of the present disclosure, each of the temples 16 and an associated connecting member 14 can be collectively rotated relative to the glasses frame 12 for folding or expanding, and the pivots 42 in the connecting members 14 are held in the front ends 46 of the temples 16 for neither undesirable appearance of the eyeglasses 10 nor unsmooth rotation of the temples 16 relative to the glasses frame 12 due to the filthy or rusty pivots. Specifically, any screw fastener (the pivots 42) cannot be seen on the eyeglasses 10 from all directions (see FIG. 1 and FIG. 8) because the pivots 42 held in the front ends 46 of the temples 16 contributes to overall appearance of the eyeglasses 10. Further, a user who intends to replace the temples 16 applies pressure on the snap-fit portion 32 of each connecting member 14 (see arrow 66 in FIG. 7) and pulls each connecting member 14 out of the associated temple 16 simultaneously, so that the snap-fit portion 32 of each connecting member 14 is separated from the rear joining groove 60 of the groove 54. On the other hand, a user who tries to assemble the temple 16 simply links the groove 54 of the temple 16 and the main body 28 of the corresponding connecting member 14 (see arrow 68 in FIG. 3) to secure the temple 16 in a short period.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A combination structure of an eyeglasses temple, comprising:
a glasses frame including two spaced lateral ends;
a connecting member pivotally fitted at one of the two lateral ends of the glasses frame and including a main body, with a pivotal portion formed on an inner face of the main body, with a snap-fit portion formed at a rear section of the main body, with a recess formed between the snap-fit portion and the pivotal portion; and
a temple including front and rear ends spaced in a length direction of the temple, with the front end of the temple detachably connected with the connecting member, with a groove formed in an inner surface of the front end of the temple, with a joining rib formed on the inner surface of the front end of the temple and extending across the groove to divide the groove into a front joining groove and a rear joining groove spaced from the front joining groove in the length direction, with the rear joining groove being in communication with the front joining groove, with the pivotal portion and the snap-fit portion of the main body respectively held in the front joining groove and the rear joining groove, with the joining rib received in the recess of the main body, with the temple and the connecting member collectively rotatable relative to the glasses frame.

2. The combination structure according to claim 1, wherein the temple further includes upper and lower ends spaced in a width direction perpendicular to the length direction of the temple, with the groove located between the upper and lower ends of the temple in the width direction, with the joining rib extending in the width direction.

3. The combination structure according to claim 1, wherein a protrusion is provided on each of upper and lower portions of the main body of the connecting member, with an indentation provided in each of upper end lower edges of the groove of the temple and engaged with one of the protrusions of the main body.

4. The combination structure according to claim 1, wherein a joining portion is formed one of the two lateral ends of the glasses frame and held in the pivotal portion of the connecting member, with a pivot engaging the joining portion with the pivotal portion, with the connecting member rotatable relative to the glasses frame about an axis defined by the pivot.

5. The combination structure according to claim 4, wherein the pivotal portion includes two spaced pivotal arms, with the joining portion of the glasses frame received between the two pivotal arms, with the joining portion provided with a through-hole, with two aligned pin holes formed in the two pivotal arms, with the pivot received in the two pin holes and the through-hole of the joining portion.
